(19) United States
(12) Patent Application Publication
(10) Pub. No.: US 2021/0162811 A1
(43) Pub. Date: Jun. 3, 2021

(54) Protective Reinforcement For A Tire For A Heavy Civil Engineering Vehicle

(71) Applicant: COMPAGNIE GENERALE DES ETABLISSEMENTS MICHELIN, Clermont-Ferrand (FR)

(72) Inventors: Alain DOMINGO, Clermont-Ferrand Cedex 9 (FR); Cédric KHAYAT, Clermont-Ferrand Cedex 9 (FR)

(21) Appl. No.: 17/048,476

(22) PCT Filed: Apr. 11, 2019
(86) PCT No.: PCT/FR2019/050856

§ 371 Date: Oct. 16, 2020

(30) Foreign Application Priority Data
Apr. 17, 2018 (FR) 1853334

(51) Int. Cl. B60C 9/20; B60C 9/00

(52) U.S. Cl. CPC B60C 9/2006; B60C 9/0007; B60C 2009/0078; B60C 2200/065; B60C 2009/2077; B60C 2009/2093; B60C 2009/208

(57) ABSTRACT

The present invention concerns a radial tire (1) for a heavy civil-engineering vehicle, and aims to increase the resistance to repeated impact of its crown reinforcement (3), when driving over stones, while maintaining good resistance to attacks. The tire (1) comprises a protective reinforcement (5) comprising at least one protective layer (51, 52) comprising elastic metal reinforcers, and a working reinforcement (6) comprising two working layers (61, 62) comprising non-extensible metal reinforcers, the elastic metal reinforcers of the radially innermost protective layer (51) have a elastic modulus in extension of at least 100 GPa and a diameter D of at least 3 mm, and are distributed axially at an axial pitch P at least 1.2 times the diameter D.

The subject matter of the present invention is a radial tire, intended to be fitted to a heavy duty civil engineering type vehicle, and the invention relates more specifically to the crown reinforcement of such a tire, and more specifically still, to the protective reinforcement thereof.

Typically, a radial tire for a heavy duty civil engineering type vehicle, within the meaning of the European Tire and Rim Technical Organisation or ETRTO standard, is intended to be mounted on a rim with a diameter at least equal to 25 inches. Although not limited to this type of application, the invention is described for a large radial tire, intended to be mounted on a dumper, a vehicle for transporting materials extracted from quarries or surface mines, by means of a rim with a diameter at least equal to 49 inches, possibly as much as 57 inches, or even 63 inches.

Since a tire has a geometry of revolution about an axis of rotation, the geometry of the tire is generally described in a meridian plane containing the axis of rotation of the tire. For a given meridian plane, the radial, axial and circumferential directions respectively denote the directions perpendicular to the axis of rotation of the tire, parallel to the axis of rotation of the tire and perpendicular to the meridian plane. The circumferential direction is tangential to the circumference of the tire.

In the following text, the expressions “radially inner/radially on the inside” and “radially outer/radially on the outside” mean “closer to” and “further away from the axis of rotation of the tire”, respectively. “Axially inner/axially on the inside” and “axially outer/axially on the outside” mean “closer to” and “further away from the equatorial plane of the tire”, respectively, with the equatorial plane of the tire being the plane passing through the middle of the tread surface and perpendicular to the axis of rotation.

Generally, a tire comprises a tread intended to come into contact with the ground via a tread surface, the two axial ends of which are connected via two sidewalls to two beads that provide the mechanical connection between the tire and the rim on which it is intended to be mounted.

A radial tire further comprises a reinforcement made up of a crown reinforcement radially on the inside of the tread and of a carcass reinforcement radially on the inside of the crown reinforcement.

The carcass reinforcement of a radial tire for a heavy duty civil engineering type vehicle usually comprises at least one carcass layer comprising generally metal reinforcers coated in a polymeric material of the elastomer or elastomeric type, obtained by blending and called coating compound. A carcass layer comprises a main part that joins the two beads together and is generally wound, in each bead, from the inside of the tire to the outside around a usually metal circumferential reinforcing element known as a bead wire so as to form a turn-up. The metal reinforcers of a carcass layer are substantially mutually parallel and form an angle of between 85 and 950 with the circumferential direction.

The crown reinforcement of a radial tire for a heavy duty civil engineering type vehicle comprises a superposition of circumferentially extending crown layers, radially on the outside of the carcass reinforcement. Each crown layer is made up of generally metal reinforcers that are mutually parallel and are coated in a polymeric material of the elastomer or coating compound type.

Among the crown layers, a distinction is usually made between the protective layers, which make up the protective reinforcement and are radially outermost, and the working layers, which make up the working reinforcement and are comprised radially between the protective reinforcement and the carcass reinforcement.

The protective reinforcement, comprising at least one protective layer, basically protects the working layers from mechanical or physicochemical attacks, which are likely to spread through the tread radially towards the inside of the tire.

The protective reinforcement often comprises two protective layers, which are radially superposed, formed of elastic metal reinforcers, are mutually parallel in each layer and are crossed from one layer to the next, forming angles at least equal to 10° with the circumferential direction.

The purpose of the working reinforcement, comprising at least two working layers, is to belt the tire and impart stiffness and road holding thereto. It absorbs both mechanical inflation stresses, which are generated by the tire inflation pressure and are transmitted by the carcass reinforcement, and mechanical stresses caused by running, which are generated as the tire runs over the ground and are transmitted by the tread. It also has to withstand oxidation and impacts and puncturing, by virtue of its intrinsic design and that of the protective reinforcement.

The working reinforcement usually comprises two working layers, which are radially superposed, are formed of inextensible metal reinforcers, are mutually parallel in each layer and are crossed from one layer to the next, forming angles at most equal to 60°, and preferably at least equal to 150 and at most equal to 45°, with the circumferential direction.

In order to reduce the mechanical inflation stresses that are transmitted to the working reinforcement, it is known practice to arrange a hoop reinforcement radially on the outside of the carcass reinforcement. The hoop reinforcement, the function of which is to at least partially absorb the mechanical inflation stresses, improves the endurance of the crown reinforcement by stiffening the crown reinforcement. The hoop reinforcement can be positioned radially on the inside of the working reinforcement, between the two working layers of the working reinforcement, or radially on the outside of the working reinforcement.

The hoop reinforcement usually comprises two radially superposed hooping layers formed of metal reinforcers which are mutually parallel within each layer and are crossed from one layer to the next, forming angles at most equal to 10° with the circumferential direction.

With respect to the metal reinforcers, a metal reinforcer is mechanically characterized by a curve representing the tensile force (in N) applied to the metal reinforcer as a function of the relative elongation (in %) thereof, known as the force-elongation curve. Mechanical tensile characteristics of the metal reinforcer, such as the structural elongation As (in %), the total elongation at break At (in %), the force at break Fm (maximum load in N) and the breaking strength Rm (in MPa) are derived from this force-elongation curve, with these characteristics being measured in accordance with the 1984 ISO 6892 standard.

The total elongation at break At of the metal reinforcer is, by definition, the sum of the respectively structural, elastic and plastic elongations thereof (At=As+Ae+Ap). The structural elongation As results from the relative positioning of the metal threads making up the metal reinforcer under a low tensile force. The elastic elongation Ae results from the intrinsic elasticity of the metal of the metal threads making up the metal reinforcer, taken individually, with the behaviour of the metal following Hooke's law. The plastic elongation Ap results from the plasticity, i.e. the irreversible deformation beyond the yield point, of the metal of these metal threads taken individually. These various elongations and the respective meanings thereof, which are well known to a person skilled in the art, are described, for example, in documents U.S. Pat. No. 5,843,583, WO2005/014925 and WO2007/090603.

A tensile modulus is also defined, at any point on the force-elongation curve of a metal reinforcer, which modulus is expressed in GPa and represents the gradient of the straight line tangential to the force-elongation curve at this point. In particular, the tensile modulus of the elastic linear part of the force-elongation curve is referred to as the tensile elastic modulus or Young's modulus.

Among the metal reinforcers, a distinction is usually made between the elastic metal reinforcers, such as those used in the protective layers, and the inextensible or non-extensible metal reinforcers, such as those used in the working layers.

An elastic metal reinforcer is characterized by a structural elongation As at least equal to 1% and a total elongation at break At at least equal to 4%. Moreover, an elastic metal reinforcer has a tensile elastic modulus at most equal to 150 GPa, and usually between 40 GPa and 150 GPa.

An inextensible metal reinforcer is characterized by a total elongation At, under a tensile force equal to 10% of the force at break Fm, at most equal to 0.2%. Moreover, an inextensible metal reinforcer has a tensile elastic modulus usually between 150 GPa and 200 GPa.

When the tire is running over stones present on the routes that the dumpers follow, the tread of the tire is subjected to repeated impacts, or hammering, which in particular generates dynamic shear stresses in the elastomeric compounds positioned in the vicinity of the axial ends of the working layers, the shear stresses being liable to lead to local cracking and, ultimately, to the breakage of the crown. This is why a person skilled in the art has conceived of a protective reinforcement and, more specifically, a radially innermost protective layer, that has an axial width greater than the axial widths of the working layers, and, more generally, than the axial widths of all the other crown layers. Such a protective layer is referred to as a protruding protective layer because it protrudes axially beyond the working layers. The radially innermost protective layer, which, of all the crown layers, has the greatest axial width, thus mechanically protects the axial end regions of the working layers against hammering, through a shock-absorbing effect.

When the tire runs over more or less sharp stones, the tread of a tire is also frequently subjected to cuts liable to pass radially through it towards the inside as far as the protective reinforcement, which acts as an obstacle to the spreading of the cracks resulting from the cuts as far as the working reinforcement: the protective reinforcement thus acts as a shield against mechanical attacks on the working reinforcement.

The inventors have set themselves the objective, for a radial tire for a heavy duty civil engineering type vehicle, of increasing the resistance of its crown reinforcement to hammering when running over stones, while at the same time maintaining a good resistance of its crown reinforcement to attacks when running over sharp stones.

This objective has been achieved, according to the invention, by a tire for a heavy duty civil engineering type vehicle, comprising a crown reinforcement radially on the inside of a tread and radially on the outside of a carcass reinforcement,
the crown reinforcement comprising, radially from the outside to the inside, a protective reinforcement and a working reinforcement,
the protective reinforcement comprising at least one protective layer comprising elastic metal reinforcers having a tensile elastic modulus at most equal to 150 GPa, coated in an elastomeric material, which are mutually parallel and which form, with a circumferential direction tangential to the circumference of the tire, an angle at least equal to 10°,
the working reinforcement comprising two working layers respectively comprising inextensible metal reinforcers having a tensile elastic modulus greater than 150 GPa and at most equal to 200 GPa, coated in an elastomeric material, which are mutually parallel and which form, with the circumferential direction, an angle at least equal to 150 and at most equal to 450 and which are crossed from one working layer to the next,
the protective reinforcement comprising a radially innermost protective layer having an axial width LP1,
the working reinforcement comprising a radially innermost working layer having an axial width LT1 at most equal to the axial width LP1,
the radially innermost protective layer comprising elastic metal reinforcers having a diameter D distributed axially at an axial spacing P,
the elastic metal reinforcers of the radially innermost protective layer having a tensile elastic modulus at least equal to 100 GPa and a diameter D at least equal to 3 mm, and being axially distributed at an axial spacing P at least equal to 1.2 times the diameter D.

The inventors, seeking to improve the hammering resistance of the crown reinforcement are proposing, in the present invention, a protective reinforcement of which the radially innermost protective layer, which protrudes beyond the radially innermost working layer of the working reinforcement, comprises elastic metal reinforcers having a sufficiently high tensile elastic modulus and a sufficiently high diameter, and which are distributed at a sufficient axial spacing. It has been found that a significant shock-absorbing effect with respect to hammering is obtained with a radially innermost protective layer that is sufficiently, although not excessively, flexible, hence the aforementioned compromise regarding the characteristics of the reinforcers. In addition, a minimum axial spacing avoids any contact between the reinforcers and the associated risk of the spread of corrosion.

Advantageously, the elastic metal reinforcers of the radially innermost protective layer have a diameter D at most equal to 6 mm. Upwards of this value, the reinforcers become excessively stiff in bending and no longer perform their shock-absorbing function, hence an increased risk of the spread of cracks through the elastomeric compounds present at the axial ends of the working layers.

Advantageously also, the elastic metal reinforcers of the radially innermost protective layer are distributed axially at an axial spacing P at most equal to 1.5 times the diameter D. Upwards of this value for the axial spacing, the space between reinforcers becomes too high and leads, in particular, to an excessive increase in the flexibility of the axial ends of the radially innermost protective layer, hence the protection against hammering becomes less effective.

According to one preferred embodiment, the elastic metal reinforcers of the protective layer are multistrand ropes of structure 1×N comprising a single layer of N strands wound in a helix, each strand comprising an internal layer of M internal threads wound in a helix and an external layer of K external threads wound in a helix around the internal layer. This type of structure gives the reinforcer an elastic behaviour as defined hereinabove.

According to a preferred variant of this preferred embodiment, the single layer of N strands, wound in a helix, comprises N=3 or N=4 strands, preferably N=4 strands.

Preferably also, the internal layer of M internal threads, wound in a helix, of each strand comprises M=3, 4 or 5 internal threads, preferably M=3 internal threads.

Preferably also, the external layer of K external threads, wound in a helix around the internal layer of each strand, comprises K=7, 8, 9, 10 or 11 external threads, preferably K=8 external threads.

A preferred example of a multistrand rope for a protective layer according to the invention has a structure of 4*(3+8)0.35 or 44.35. It is a multistrand rope having N=4 strands, each strand comprising an internal layer of M=3 internal threads wound in a helix and an external layer of K=8 external threads wound in a helix around the internal layer, the threads having a section of diameter d=0.35 mm.

The metal reinforcers of the protective layer advantageously form an angle at least equal to 150 and at most equal to 35 with the circumferential direction. This is a range of values commonly encountered in the design of protective layers.

The radially innermost protective layer preferably has an axial width LP1 at least equal to 1.05 times and at most equal to 1.25 times the axial width LT1 of the radially innermost working layer. Below 1.05 times the axial width LT1, the radially innermost protective layer does not protrude sufficiently with respect to the radially innermost working layer to be able to afford the latter effective protection against hammering. Beyond 1.25 times the axial width LT1, the axial end of the radially innermost protective layer is very close to the axial end of the tread, thereby increasing the risk of cracking between the axial end of the said protective layer and the axial end of the tread.

The elastic metal reinforcers of the radially innermost protective layer advantageously form, with the circumferential direction, an angle equal to that formed by the inextensible metal reinforcers of the radially innermost working layer. These angles are oriented in the same direction with respect to the equatorial plane of the tire and are therefore equal in terms of algebraic value. In other words, the reinforcers of the said protective layer are parallel to those of the said working layer, thereby reducing shear, and therefore the risk of cracking in the vicinity of the axial end of the said working layer.

Preferably, the protective reinforcement comprises two protective layers, the respective metal reinforcers of which are crossed from one protective layer to the next. A protective reinforcement having two layers that are crossed relative to one another is a usual design in the field of tires for a heavy duty civil engineering type vehicle.

The crown reinforcement preferably also comprises a hoop reinforcement comprising two hooping layers, of which the respective metal reinforcers, which are coated in an elastomeric material, are mutually parallel and form an angle at most equal to 100 with the circumferential direction, are crossed from one hooping layer to the next. A distinction is usually made between angled hooping layers, with reinforcers that form angles at least equal to 6° and at most equal to 8°, and circumferential hooping layers, with reinforcers that are substantially circumferential forming angles close to 0° and at most equal to 5°. The metal reinforcers of the hooping layer may be either elastic or inextensible. The hoop reinforcement can be positioned radially on the inside of the working reinforcement, between the two working layers of the working reinforcement, or radially on the outside of the working reinforcement.

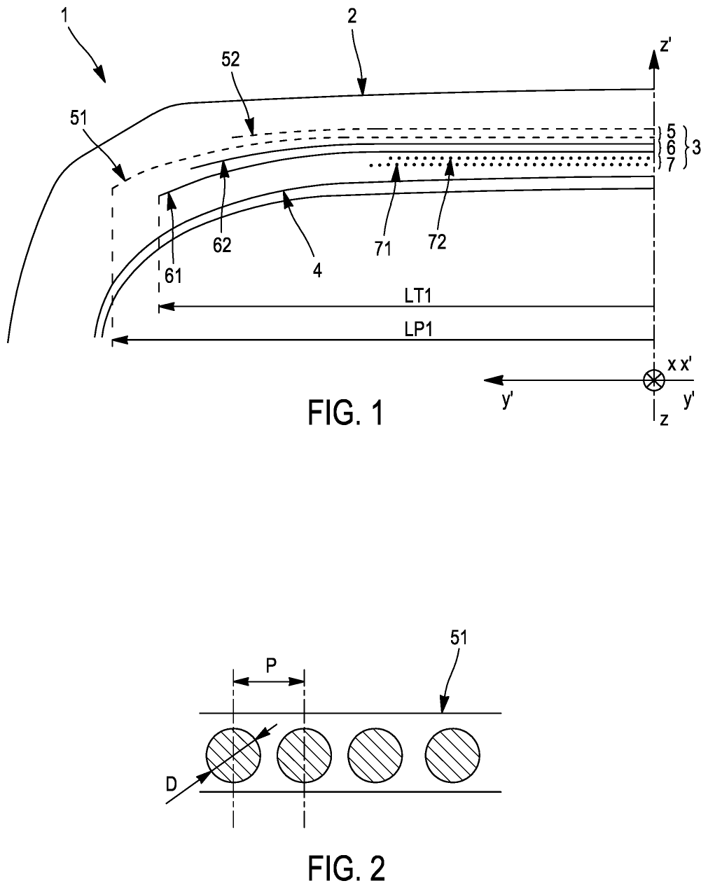

The features of the invention are illustrated in the FIGS. 1 and 2, which are schematic and not to scale, with reference to a tire of size 53/80R63:

FIG. 1 is a meridian cross section through a crown of a tire for a heavy duty vehicle of dumper type according to the invention.

FIG. 2 is a meridian cross section through a portion of the radially innermost protective layer according to the invention.

FIG. 1 shows a meridian cross section through a tire 1 for a heavy duty civil engineering type vehicle of size 53/80R63, comprising a crown reinforcement 3 radially on the inside of a tread 2 and radially on the outside of a carcass reinforcement 4. The crown reinforcement 3 comprises, radially from the outside to the inside, a protective reinforcement 5, a working reinforcement 6 and a hoop reinforcement 7. The protective reinforcement 5 comprises two protective layers (51, 52) comprising elastic metal reinforcers that are coated in an elastomeric material, are mutually parallel and form an angle equal to 330 with a circumferential direction XX′ tangential to the circumference of the tire, the respective metal reinforcers of each protective layer being crossed from one protective layer to the next. The working reinforcement 6 comprises two working layers (61, 62), of which the respective metal reinforcers, which are inextensible, are coated in an elastomeric material, are mutually parallel and form with the circumferential direction XX′ angles respectively equal to 33°, in the case of the radially innermost working layer 61, and 24°, in the case of the radially outermost working layer 62, are crossed from one working layer to the next. The radially innermost protective layer 51 protrudes axially beyond the radially innermost working layer 61, which is to say that the radially innermost protective layer 51 has an axial width LP1 greater than the axial width LT1 of the radially innermost working layer 61. In the case depicted, the axial width LP1 is equal to 1.2 times the axial width LT1. The hoop reinforcement 7 comprises two hooping layers (71, 72), of which the respective metal reinforcers, which are coated in an elastomeric material, are mutually parallel and form an angle of between 6° and 10 with the circumferential direction XX′, are crossed from one hooping layer to the next.

FIG. 2 shows a meridian cross section through a portion of the radially innermost protective layer 51. The protective layer metal reinforcers each have a cross section of diameter D and are spaced apart one from the next by an axial spacing P at least equal to 1.2 times the diameter D, the axial spacing P being the axial distance between the respective centres of the circular cross sections of two consecutive reinforcers.

The inventors have compared a tire according to the invention, I, against a reference tire R, for the tire size 53/80R63, the respective technical features of which are given in Table 1 below:

TABLE 1

| | Dimension 53/80R63 | | | |
|---|---|---|---|---|
| | | | Tire according to the | |
| | Reference tire R | | invention I | |
| Type of reinforcer | 24.26 = 4*(1 + 5)*26 | | 44.35 = 4*(3 + 8)*35 | |
| Tensile elastic modulus | 110 | GPa | 130 | GPa |
| M of a reinforcer | | | | |
| Diameter D of a | 1.9 | mm | 3.8 | mm |
| reinforcer | | | | |
| Axial spacing P of a | 2.5 | mm | 4.9 | mm |
| reinforcer | | | | |
| Axial width LP1 | 1120 | mm | 1120 | mm |
| Axial width LT1 | 1000 | mm | 930 | mm |

The reference tire R has a radially innermost protective layer that has an axial width LP1 equal to 1120 mm, which is 120 mm greater than the axial width LT1 of the radially innermost working layer. The elastic metal reinforcers of the radially innermost protective layer are multistrand ropes of structure 24.26, namely made up of N=4 strands, each strand comprising an internal layer of M=1 internal thread and an external layer of K=5 external threads wound in a helix around the internal layer, the threads having a section of diameter d=0.26 mm. In addition, these reinforcers have a tensile elastic modulus equal to 110 GPa, a diameter D equal to 1.9 mm, and are axially distributed at an axial spacing P equal to 2.5 mm, namely equal to 1.32 times the diameter D.

The tire according to the invention, I, has a radially innermost protective layer that has an axial width LP1 equal to 1120 mm, which is 190 mm greater than the axial width LT1 of the radially innermost working layer, and therefore equal to 1.2 times the axial width LT1. The elastic metal reinforcers of the radially innermost protective layer are multistrand ropes of structure 44.35, namely made up of N=4 strands, each strand comprising an internal layer of M=3 internal threads wound in a helix, and an external layer of K=8 external threads wound in a helix around the internal layer, the threads having a section of diameter d=0.35 mm. In addition, these reinforcers have a tensile elastic modulus equal to 130 GPa, which is therefore higher than 100 GPa, a diameter D equal to 3.8 mm, which is therefore higher than 3 mm, and are axially distributed at an axial spacing P equal to 4.9 mm, namely equal to 1.3 times the diameter D, and therefore greater than 1.2 times the diameter D.

The inventors have demonstrated by finite-element numerical simulations that the shear in the elastomeric compounds positioned between the metal reinforcers of the axial end portions of the radially innermost working layer, and in the elastomeric compounds positioned radially on the inside or on the outside of the said axial end portions, was reduced by 15% to 25% for the tire according to the invention I as compared with the reference tire R. The inventors have also demonstrated, through experimental running via the client base, that the service life of the tire according to the invention, I, before being removed from the vehicle, was increased by approximately 12% with respect that the reference tire R.

1. A tire for a heavy duty civil engineering type vehicle, comprising a crown reinforcement radially on the inside of a tread and radially on the outside of a carcass reinforcement;
the crown reinforcement comprising, radially from the outside to the inside, a protective reinforcement and a working reinforcement,
the protective reinforcement comprising at least one protective layer comprising elastic metal reinforcers having a tensile elastic modulus at most equal to 150 GPa, coated in an elastomeric material, which are mutually parallel and which form, with a circumferential direction (XX′) tangential to the circumference of the tire, an angle at least equal to 10°,
the working reinforcement comprising two working layers respectively comprising inextensible metal reinforcers having a tensile elastic modulus greater than 150 GPa and at most equal to 200 GPa, coated in an elastomeric material, which are mutually parallel and which form, with the circumferential direction (XX′), an angle at least equal to 15° and at most equal to 45° and which are crossed from one working layer to the next,
the protective reinforcement comprising a radially innermost protective layer having an axial width LP1,
the working reinforcement comprising a radially innermost working layer having an axial width LT1 at most equal to the axial width LP1,
the radially innermost protective layer comprising elastic metal reinforcers having a diameter D distributed axially at an axial spacing P,
wherein the elastic metal reinforcers of the radially innermost protective layer have a tensile elastic modulus at least equal to 100 GPa and a diameter D at least equal to 3 mm, and are axially distributed at an axial spacing P at least equal to 1.2 times the diameter D.

2. The tire according to claim 1, wherein the elastic metal reinforcers of the radially innermost protective layer have a diameter D at at most equal to 6 mm.

3. The tire according to claim 1, wherein the elastic metal reinforcers of the radially innermost protective layer are distributed axially at an axial spacing P at most equal to 1.5 times the diameter D.

4. The tire according to claim 1, wherein the elastic metal reinforcers of the protective layer are multistrand ropes of structure 1×N comprising a single layer of N strands wound in a helix, each strand comprising an internal layer of M internal threads wound in a helix and an external layer of K external threads wound in a helix around the internal layer.

5. The tire according to claim 4, wherein the single layer of N strands, wound in a helix, comprises N=3 or N=4 strands.

6. The tire according to claim 4, wherein the internal layer of M internal threads, wound in a helix, of each strand comprises M=3, 4, or 5 internal threads.

7. The tire according to claim 4, wherein the external layer of K external threads, wound in a helix around the internal layer of each strand, comprises K=7, 8, 9, 10 or 11 external threads.

8. The tire according to claim 1, wherein the metal reinforcers of the protective layer form an angle at least equal to 15° and at most equal to 35° with the circumferential direction (XX′).

9. The tire according to claim 1, wherein the radially innermost protective layer has an axial width LP1 at least equal to 1.05 times and at most equal to 1.25 times the axial width LT1 of the radially innermost working layer.

10. The tire according to claim 1, wherein the elastic metal reinforcers of the radially innermost protective layer form, with the circumferential direction (XX′), an angle equal to that formed by the inextensible metal reinforcers of the radially innermost working layer.

11. The tire according to claim 1, wherein the protective reinforcement comprises two protective layers, the respective metal reinforcers of which are crossed from one protective layer to the next.

12. The tire according to claim 1, wherein the crown reinforcement comprises a hoop reinforcement comprising two hooping layers, of which the respective metal reinforcers, which are coated in an elastomeric material, are mutually parallel and form an angle at most equal to 10° with the circumferential direction (XX), are crossed from one hooping layer to the next.
